(19) United States
(12) Patent Application Publication
(10) Pub. No.: US 2016/0119697 A1
(43) Pub. Date: Apr. 28, 2016

(54) AUDIO EQUIPMENT AND ELECTRONIC DEVICE

(71) Applicant: HON HAI PRECISION INDUSTRY CO., LTD., New Taipei (TW)

(72) Inventor: KUO-HSIANG OU YANG, New Taipei (TW)

(21) Appl. No.: 14/527,403

(22) Filed: Oct. 29, 2014

(30) Foreign Application Priority Data
Oct. 24, 2014 (TW) 103136931

(51) Int. Cl. H04R 1/02

(52) U.S. Cl. CPC H04R 1/02

(57) ABSTRACT

An audio equipment includes a housing configured to be mounted in an enclosure of an electronic device, an audio device, and a supporting panel mounted in the enclosure. The supporting panel defines a cavity. The audio device is mounted in the cavity. The housing defines a plurality of holes. A diaphragm of the audio device faces the housing and is aligned with the holes. The holes communicate with the cavity. An electronic device is also provided.

### CROSS-REFERENCE TO RELATED APPLICATIONS

This application claims priority to Taiwan Patent Application No. 103136931 Oct. 24, 2014, the contents of which are incorporated by reference herein.

### FIELD

The subject matter herein generally relates to an electronic device and in particular to audio equipment of an electronic device.

### BACKGROUND

Audio equipment in an electronic device may be used for the transmission of sound.

### BRIEF DESCRIPTION OF THE DRAWINGS

Implementations of the present technology will now be described, by way of example only, with reference to the attached figures.

FIG. 1 is an isometric, assembled view of one embodiment of an electronic device.

FIG. 2 is a cross-sectional view of the electronic device of FIG. 1 along a line II-II.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “comprising,” when utilized, means “comprising, but not necessarily limited to”; it specifically indicates open-ended inclusion or membership in the so-described combination, group, series, and the like.

The present disclosure is described in relation to audio equipment.

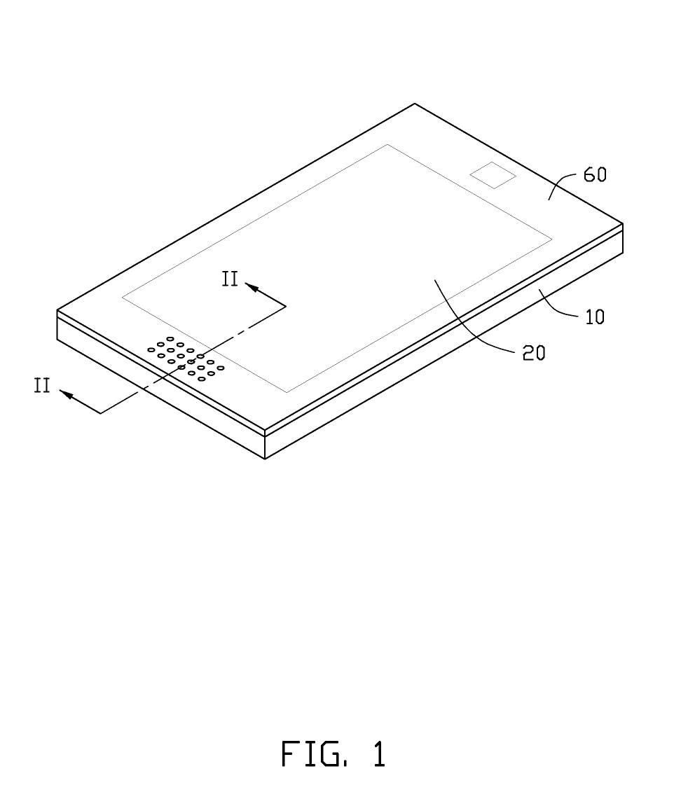

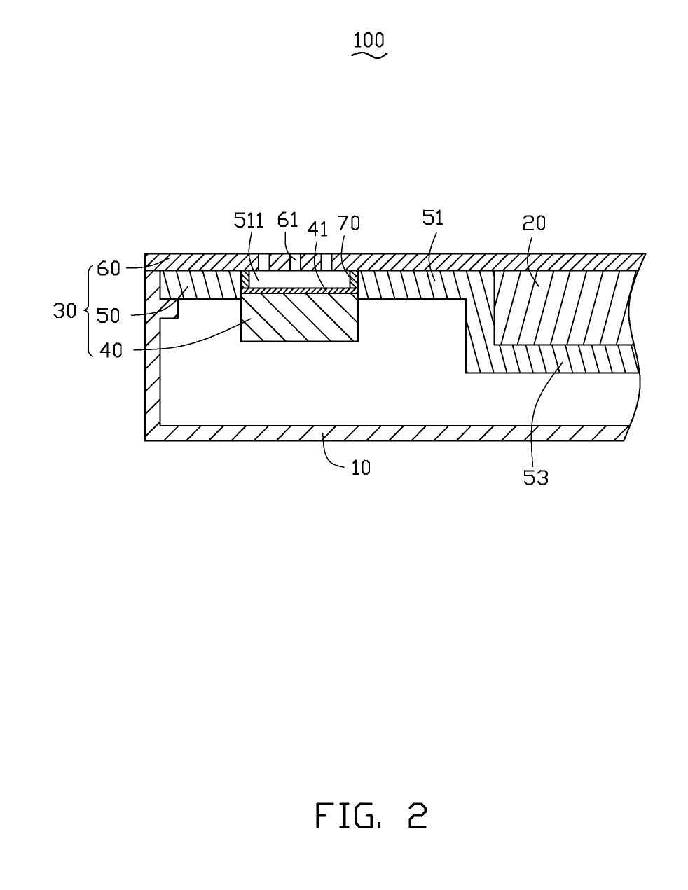

FIGS. 1 and 2 illustrate an embodiment of an electronic device 100. The electronic device 100 comprises an enclosure 10, a display 20 mounted in the enclosure 10, and audio equipment 30. In one embodiment, the display 20 is a liquid crystal display.

The audio equipment 30 comprises an audio device 40, a supporting panel 50, and a housing 60. In one embodiment, the audio device 40 is a loudspeaker. The audio device 40 comprises a diaphragm 41.

The supporting panel 50 comprises a first mounting portion 51 and a second mounting portion 53. The first mounting portion 51 defines a cavity 511. The cavity 511 extends through the first mounting portion 51. In one embodiment, the first mounting portion 51 is substantially parallel to the second mounting portion 53.

The housing 60 defines a plurality of holes 61 communicating with the cavity 511. The holes 61 are aligned with the diaphragm 41. Each hole 61 extends through the housing 60. In one embodiment, a diameter of each hole 61 is equal to each other.

In assembly, the supporting panel 50 is mounted in the enclosure 10. The display 20 is mounted on the second mounting portion 53. The audio device 40 is mounted in the cavity 511. Adhesive 70 is applied between an inner sidewall of the cavity 511 and the sidewall of the audio device 40. A first space between the audio device 40 and the inner sidewall of the cavity 511 is filled with the adhesive 70. The housing 60 is mounted in the enclosure 10. One side of the display 20 touches the second mounting portion 53. The other side of the display 20 touches the housing 60. The first mounting portion 51 tightly touches the housing 60. The diaphragm 41 faces the housing 60. The holes 61 are aligned with the diaphragm 41 and communicate with the cavity 511. The audio device 40 is mounted to the housing 60 via the adhesive 70. A second space between the inner sidewall of the cavity 511 and the first mounting portion 51 is filled with the adhesive 70, thus the audio from the audio device 40 can sound out from the holes 61. A distance between the housing 60 and the audio device 40 is less than a thickness of the first mounting portion 51.

It is to be understood that even though numerous characteristics and advantages have been set forth in the foregoing description of embodiments, together with details of the structures and functions of the embodiments, the disclosure is illustrative only and changes may be made in detail, including in the matters of shape, size, and arrangement of parts within the principles of the disclosure to the full extent indicated by the broad general meaning of the terms in which the appended claims are expressed.

What is claimed is:

1. An audio equipment comprising:
a housing configured to be mounted in an enclosure of an electronic device and having a plurality of holes;
a supporting panel mounted in the enclosure and having a cavity defined therein; and
an audio device mounted in the cavity,
wherein a diaphragm of the audio device faces the housing and is aligned with the holes, and the holes communicate with the cavity.

2. The audio equipment of claim 1, wherein adhesive is mounted on an inner sidewall of the cavity, the audio device is mounted on the housing via the adhesive, a first space between the audio device and the inner sidewall of the cavity is filled with the adhesive, and a second space between the housing and the inner sidewall of the cavity is filled with the adhesive.

3. The audio equipment of claim 2, wherein the supporting panel comprises a first mounting portion tightly touching the housing and the cavity is defined in the first mounting portion.

4. The audio equipment of claim 3, wherein a distance between the housing and the audio device is less than a thickness of the first mounting portion.

5. The audio equipment of claim 3, wherein the supporting panel further comprises a second mounting portion configured to securing a display.

6. The audio equipment of claim 5, wherein the second mounting portion is substantially parallel to the first mounting portion.

7. The audio equipment of claim 3, wherein the cavity extends through the first mounting portion.

8. The audio equipment of claim 1, wherein a diameter of each hole is equal to each other.

9. The audio equipment of claim 1, wherein each hole extends through the housing.

10. An electronic device comprising:
an enclosure; and
an audio equipment having:
a housing configured to be mounted in the enclosure and having a plurality of holes,
a supporting panel mounted in the enclosure and having a cavity defined therein, and
an audio device mounted in the cavity;
wherein a diaphragm of the audio device faces the housing and is aligned with the holes, and the holes communicate with the cavity.

11. The electronic device of claim 10, wherein the audio device is mounted on the housing via adhesive, the adhesive is mounted on the inner sidewall of the cavity, a first space between the audio device and the inner sidewall of the cavity is filled with the adhesive, and a second space between the housing and the inner sidewall of the cavity is filled with the adhesive.

12. The electronic device of claim 11, wherein the supporting panel comprises a first mounting portion tightly touching the housing and the cavity is defined in the first mounting portion.

13. The electronic device of claim 12, wherein a distance between the housing and the audio device is less than a thickness of the first mounting portion.

14. The electronic device of claim 12, further comprises a display, wherein the supporting panel further comprises a second mounting portion, and the display is mounted between the second mounting portion and the housing.

15. The electronic device of claim 14, wherein the second mounting portion is substantially parallel to the first mounting portion.

16. The electronic device of claim 12, wherein the cavity extends through the first mounting portion.

17. The electronic device of claim 10, wherein a diameter of each hole is equal to each other.

18. The electronic device of claim 10, wherein each hole extends through the housing.
